(19) United States
(12) Patent Application Publication
(10) Pub. No.: US 2010/0207950 A1
(43) Pub. Date: Aug. 19, 2010

(54) DEFINING SIMPLE AND COMPLEX ANIMATIONS

(75) Inventors: Jason Xiaobo Zhao, San Jose, CA (US); Mark Pearson, Renton, WA (US); Julie Ann Guinn, Seattle, WA (US); Erin Dean, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/371,929

(22) Filed: Feb. 17, 2009

(51) Int. Cl. G06T 15/70

(52) U.S. Cl. 345/473

(57) ABSTRACT

A unified user interface (“UI”) is provided that includes functionality for defining both simple and complex animations for an object. The unified UI includes a UI for defining a single animation for an object and a UI for defining a more complex animation. The UI for defining a single animation for an object includes a style gallery and an effects options gallery. The UI for defining two or more animations for a single object includes a style gallery for selecting two or more animation classes to be applied to an object, one or more user interface controls for specifying the timing and order of the two or more animations, and an on-object user interface (“OOUI”) displayed adjacent to each object for providing a visual indication of the two or more animations and for providing an indication when an animation includes two or more build steps.

### BACKGROUND

Electronic presentation application programs allow users to create high-impact dynamic slide presentations that include text, graphics, media objects, and other types of objects. Some presentation applications even provide functionality for animating the objects on a slide. Animating objects in a slide presentation can be a powerful way to attract and focus the attention of an audience. For instance, it may be possible to animate text, graphics, diagrams, charts, and media objects to focus an audience on important points in a presentation, to control the flow of information in the presentation, and to add visual flair to the presentation.

Previous presentation application programs typically provide all users with one complicated user interface (“UI”) for defining animations. While such a complicated UI is appropriate for advanced users that choreograph multiple animations and animation timelines, this type of UI is typically overly complex for the bulk of users that simply wish to define a single animation per object. As a result, previous UIs for defining object animations can be frustrating for many users.

It is with respect to these considerations and others that the disclosure made herein is presented.

### SUMMARY

Technologies are described herein for defining simple and complex animations. In particular, through the utilization of the concepts and technologies presented herein, a mechanism is provided through which a user can easily and quickly define a simple animation that includes a single animation per object. The same mechanism also provides more advanced functionality through which a user may also define a complex custom animation that includes multiple animations per object and sequence the multiple animations in a complex timeline. Transitioning between the functionality for defining a simple animation and the functionality for defining a complex animation can be done in an intuitive manner.

In one embodiment, a unified user interface is provided that includes functionality for defining both simple and complex animations for an object. In one implementation, the unified user interface includes a user interface for defining a single animation for an object. This user interface is suitable for use by users that want to easily define a simple animation on an object. The unified user interface also includes a user interface for defining a more complex animation. This user interface provides functionality for defining two or more animations on an object, for specifying the order of the animations, and for performing other advanced functions. This user interface is suitable for users wanting nearly complete control over the number of animations applied to an object and the manner in which the animations are performed.

According to embodiments, the user interface for defining a single animation for an object includes a style gallery through which a user may graphically select a single animation class to be applied to an object. The style gallery includes graphical representations of the available animations that can be selected using an appropriate user input device in order to apply a selected animation to an object. Selection of one of the graphical representations will cause a default variant of the selected animation class to be applied to a selected object. The user interface for defining a single animation may also include an effects options gallery for specifying one or more variants of a selected animation class.

According to other embodiments, the user interface for defining two or more animations for a single object includes a style gallery for selecting two or more animation classes to be applied to the object. The style gallery includes graphical representations of the available animations that can be selected using an appropriate user input device in order to apply a selected animation to an object. Selection of one of the graphical representations will cause the selected animation class to be added to a selected object in addition to other animations previously specified for the object. The user interface for defining two or more animations for a single object may also include one or more user interface controls for specifying the timing and order of the two or more animations, and an on-object user interface (“OOUI”) displayed adjacent to each object for providing a visual indication of the two or more animations and for providing an indication when one of the animations includes two or more build steps.

Through the user interfaces described above, user input is received defining one or more animations on an object. Once a user has defined the one or more animations utilizing the unified user interface provided herein, data defining the animations is transformed in order to generate the animations on a display screen of a computing system.

It should be appreciated that the above-described subject matter may also be implemented as a computer-controlled apparatus, a computer process, a computing system, as an article of manufacture such as a computer-readable medium, or in another manner. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIG. 1 is a user interface diagram showing aspects of a unified user interface provided in one embodiment presented herein for defining both a simple animation and a complex animation;

FIGS. 2-3 are user interface diagrams showing aspects of one user interface provided herein for defining a simple animation;

FIG. 4 is a flow diagram showing aspects of one illustrative process presented herein for defining and executing a simple animation;

FIGS. 5-8 are user interface diagrams showing aspects of one user interface provided herein for defining a complex animation;

FIG. 9 is a flow diagram showing aspects of one illustrative process presented herein for defining and executing a complex animation; and

FIG. 10 is a computer architecture diagram showing an illustrative computer hardware and software architecture for a computing system capable of implementing aspects of the embodiments presented herein.

### DETAILED DESCRIPTION

The following detailed description is directed to concepts and technologies for defining simple and complex animations. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks, implement particular abstract data types, and transform data. Moreover, those skilled in the art will appreciate that the subject matter described herein may be practiced with or tied to other specific machines, computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, technologies for triggering animation actions and media object actions will be described.

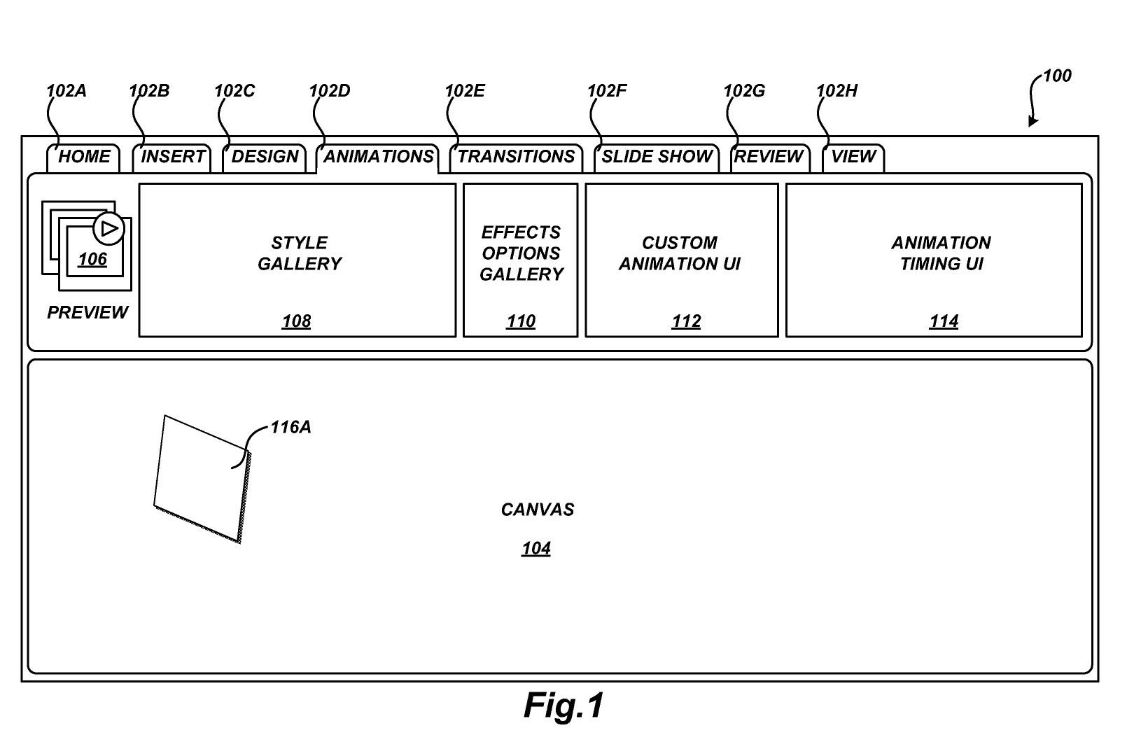

Turning now to FIG. 1, details will be provided regarding an illustrative unified user interface 100 provided by an application program for defining an animation sequence. The unified user interface 100 illustrated in FIG. 1 is provided by a presentation application in one embodiment, such as the POWERPOINT presentation application from MICROSOFT CORPORATION of Redmond, Wash. It should be appreciated, however, that the embodiments presented herein may be utilized with other presentation applications from other manufacturers and with other types of software applications that provide functionality for the creation and playback of animation sequences.

As shown in FIG. 1, the unified user interface 100 includes a canvas 104 in one embodiment. A user may insert objects onto the canvas 104, such as the object 116A, and define animation actions to be applied to the objects to create an animation sequence. Objects that may be placed on the canvas 104 may include static objects like shapes, text, clip art, and images, and media objects like movies and audio files. It should be appreciated that virtually any number of objects may be placed on the canvas 104.

Once an object has been placed onto the canvas 104, one or more animation actions, which may be referred to herein as “animations”, may be defined with respect to the object. Virtually any number of animation actions may be applied to an object. Animation actions include, but are not limited to, operations that cause an object to spin, fade in, fade out, move across the canvas 104, split, descend, ascend, expand, or change color. Other types of animation actions may also be utilized.

According to one implementation, the user interface 100 includes a number of tabs 102A-102H which, when selected, will cause a corresponding user interface to be displayed for performing certain actions. For instance, selection of the tab 102E with an appropriate user interface device will cause a user interface to be provided for defining transitions between slides. Selection of the tab 102D using an appropriate user input device will cause the user interface 100 shown in FIG. 1 to be displayed for defining animations with respect to objects placed on the canvas 104.

In one embodiment, the unified user interface 100 includes a user interface through which a user can easily and quickly define a simple animation that includes a single animation per object. The unified user interface 100 also provides more advanced functionality through which a user may also define a complex custom animation that includes multiple animations per object and sequence the multiple animations in a complex timeline. Transitioning between the functionality for defining a simple animation and the functionality for defining a complex animation can be done in an intuitive manner as discussed below.

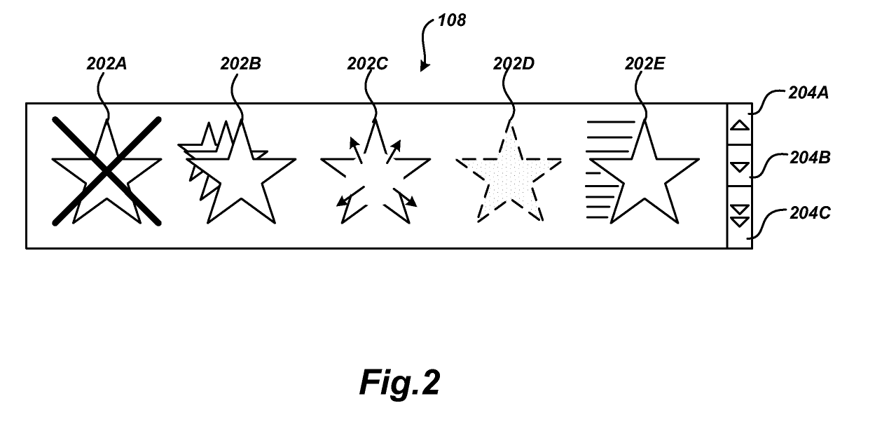

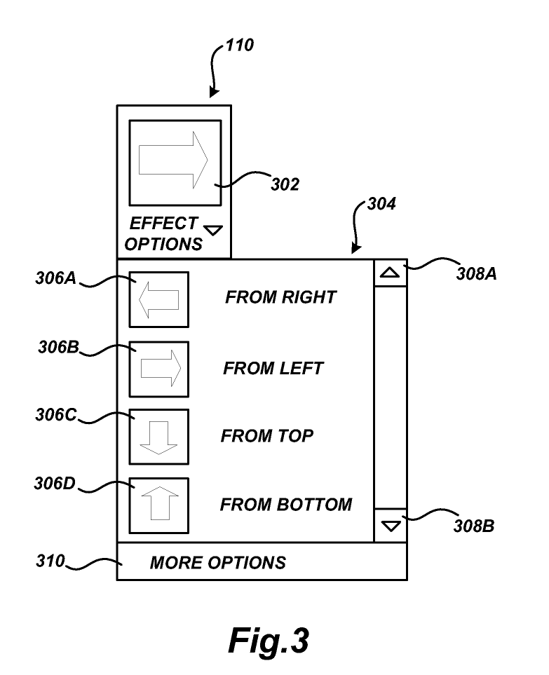

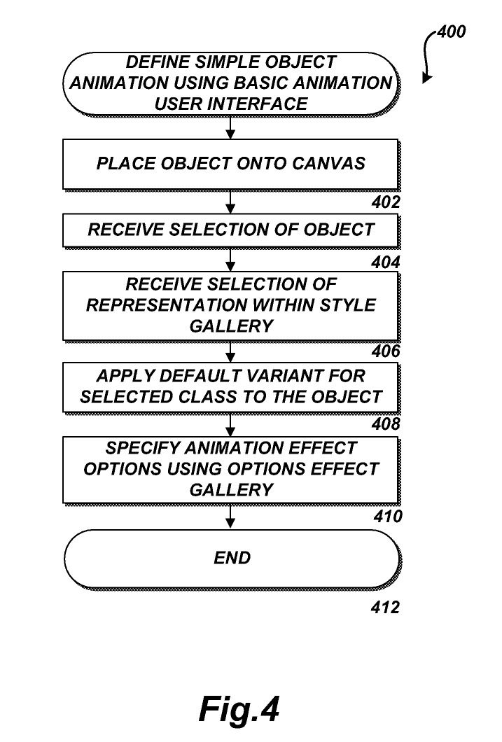

According to an embodiment, the user interface for defining simple animations includes a style gallery 108 and an effects options gallery 110. The style gallery 108 and the effects options gallery 110 will be described below with respect to FIGS. 2 and 3, respectively. Additional details regarding the functionality provided herein for defining a simple animation will be provided with respect to FIG. 4.

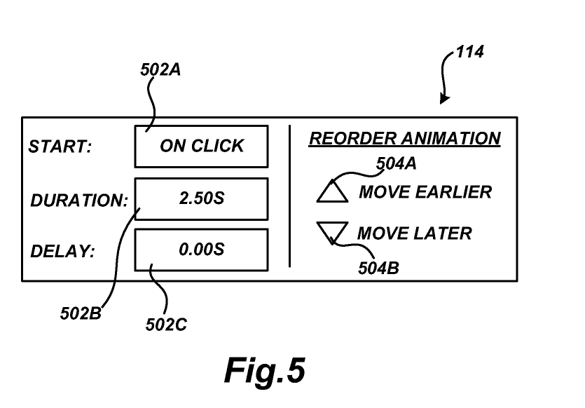

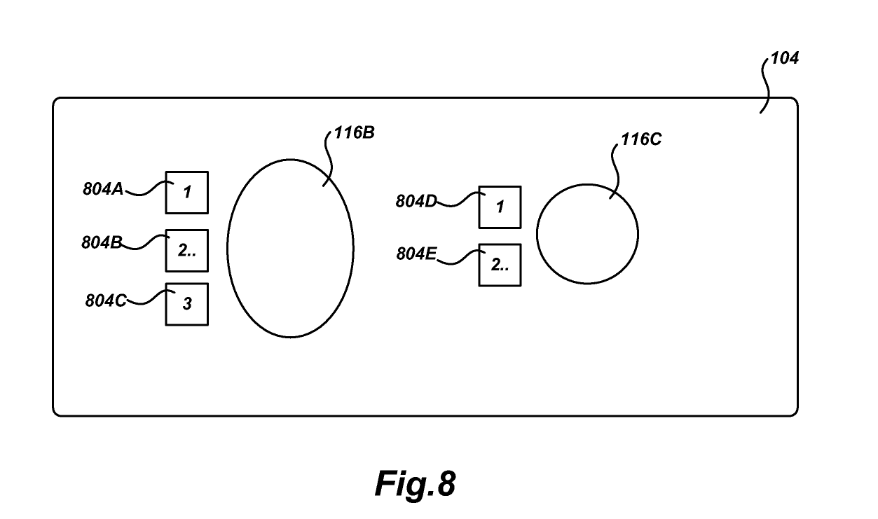

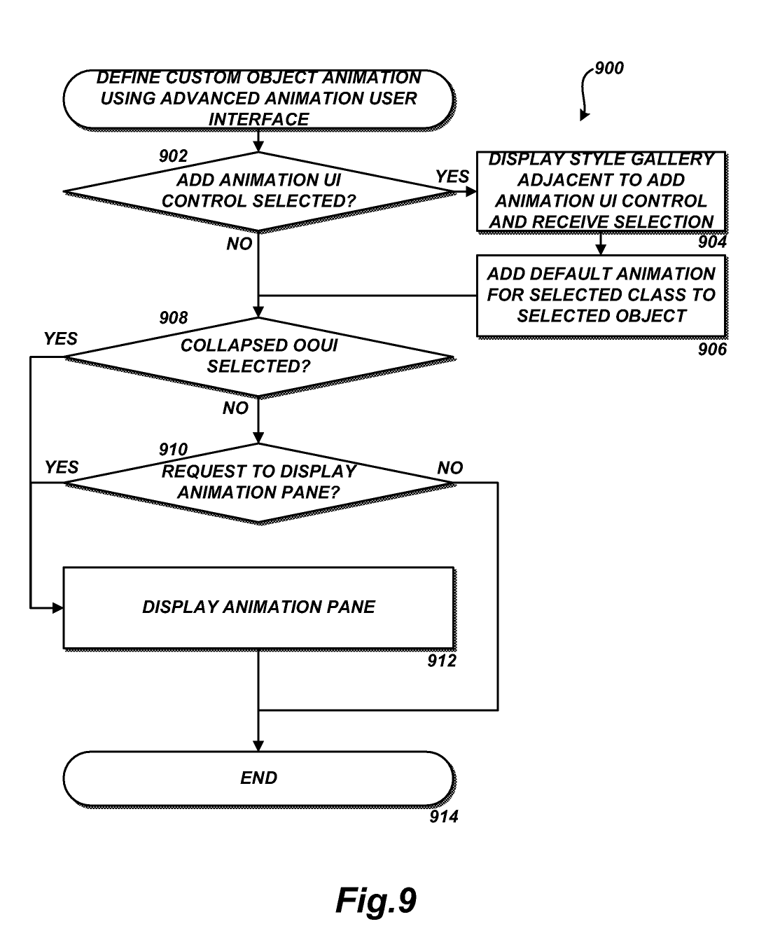

In one implementation, the user interface for defining more complex animations includes the animation timing UI 114 and the custom animation UI 112. Details regarding the operation of the animation timing UI 114 and the custom animation UI 112 will be provided below with respect to FIGS. 5-7. Other aspects of the user interfaces for defining complex animations provided herein will be discussed with reference to FIGS. 8-9. According to one embodiment, a user interface button 106 is provided within the unified user interface 100 that may be utilized to preview the animations defined for objects on the canvas 104.

Referring now to FIG. 2, additional details will be provided regarding aspects of one user interface provided herein for defining a simple animation. In particular, FIG. 2 shows a style gallery 108 provided in one implementation. The style gallery 108 becomes active and can receive user input when an object on the canvas 104 has been selected using an appropriate user input device. The style gallery 108 includes a number of graphical representations 202A-202E corresponding to animation classes available for application to an object. An animation class is an abstract grouping of similar animation effects. For instance, an animation class might be created for animations that cause an object to “fly-in” from the edges of the canvas 104.

According to one embodiment, the graphical representations 202A-202E are icons that provide a visual hint as to functionality provided by the corresponding animation class. Alternatively, the graphical representations 202A-202E may comprise text that identifies the corresponding animation class. In another embodiment, both graphics and text may be utilized for the graphical representations 202A-202E.

In the example style gallery 108 shown in FIG. 2, five graphical representations 202A-202E are shown. It should be appreciated, however, that the style gallery 108 may be resized and that more or fewer graphical representations 202A-202E may be shown. It should also be appreciated that the user interface buttons 204A-204B may be selected in order to view graphical representations for additional available animation classes within the style gallery 108. Moreover, the user interface button 204C may be selected to cause a drop-down or pop-up window to be displayed with additional available animation classes organized by category or in another manner. In this way, a large number of animation classes can be presented to a user.

In response to receiving the selection of one of the graphical representations 202A-202E from the style gallery 108, a default animation for the animation class corresponding to the selected graphical representation 202A-202E will be applied to the selected object on the canvas 104. In particular, the default animation will replace any and all animations that were previously defined for the selected object. If multiple objects have been selected, the default animation will replace any animations that were previously applied to the selected objects. In this manner, a single animation can be applied to a selected object with a single selection of a graphical representation 202A-202E within the style gallery 108.

Turning now to FIG. 3, additional details will be provided regarding aspects of a user interface provided herein for defining a simple animation. In particular, FIG. 3 shows aspects of the effects options gallery 110 in one embodiment presented herein. The effects options gallery 110 provides functionality for specifying a variant of an animation class for an object. Variants are variations on a particular animation class. For instance, as discussed above, an animation class might be created for animations that cause an object to “fly-in” from the edges of the canvas 104. Variants for this animation class might include variations on the direction from which the object “flies-in.” For instance, variants might include “from right”, “from left”, “from top”, and “from bottom.” Once of the variants is defined as a default animation for an animation class.

In one embodiment, the effects options gallery 110 includes a user interface button 302 which, when selected, causes the menu 304 to be displayed. The menu 304 includes selectable representations 306A-306D for each of the variants available for the animation class that has been applied to a selected object on the canvas 104. In the example shown in FIG. 3, a “fly-in” animation class has been defined on an object, such as the object 116A. As a result, the menu 304 includes selectable representations 306A-306D corresponding to variants for “fly-in” from right, “fly-in” from left, “fly-in” from top, and “fly-in” from bottom. Selection of one of the representations 306A-306D will cause the corresponding variant of the selected animation class to be defined for use with selected object. The user interface controls 308A-308B may be selected to view additional available variants for the selected object.

According to embodiments, a user interface button 310 is also provided within the menu 304. When the user interface button 310 is selected, a user interface may be provided for specifying additional options for the variant. For instance, with respect to the “fly-in” animation class, a dialog box is presented in one embodiment for specifying the direction of the “fly-in”, options relating to smoothing of the animation, sound, and timing. A user interface for specifying other types of options may also be provided for specifying options with respect to other animation classes.

It should be appreciated that while the user interface shown in FIG. 3 allows a user to specify one axis of variation (e.g. the direction from which the object will “fly-in”), the same user interface may also be utilized to specify two or more axes of variation for an animation class. In this embodiment, the menu 304 may be configured for multi-selection, thereby allowing a user to specify a desired variant for each axis of variation.

Referring now to FIG. 4, additional details will be provided regarding the embodiments presented herein for defining simple and complex animations. In particular, FIG. 4 is a flow diagram showing a routine 400 that illustrates aspects of the operation of an application program in one implementation for providing a user interface for defining a single animation for an object.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 400 begins at operation 402, where an object, such as the object 116A, is placed onto the canvas 104. The routine 400 then continues to operation 404, where the object is selected using an appropriate user input device, such as a mouse, keyboard, or touch screen. As discussed above, the style gallery 108 is activated in response to the selection of an object on the canvas 104.

From operation 404, the routine 400 proceeds to operation 406 where a selection of one of the representations 202A-202E is made from within the style gallery 108. As discussed above, the graphical representations 202A-202E correspond to animation classes available for application to an object. Selection of one of the representations 202A-202E will cause the default variant for the corresponding animation class to be applied to the selected object. This occurs at operation 408. Once the animation class has been specified for the selected object, the routine 400 proceeds to operation 410 where the effects options gallery 110 may be utilized to specify a variant of the animation class specified for use with the selected object. Other options may also be specified in the manner described above. From operation 410, the routine 400 proceeds to operation 412, where it ends.

Once an animation has been specified for an object, the object may be animated in the defined manner. In order to animate the object, data that defines the manner in which the specified animations are to be performed may be transformed to generate a display of the defined animation on a computer display screen. Other types of transformations may also be performed in order to cause the defined animation to be displayed on the computer display screen.

It should be appreciated that the style gallery 108 and the effects options gallery 110 may be utilized in the manner described above to quickly and easily define a simple animation with respect to an object. In order to specify more complex animations, additional aspects of the unified user interface 100 may be utilized. In particular, the custom animation UI 112 and the animation timing UI 114 may be utilized.

As shown in FIG. 5, the animation timing UI 114 provides fields 502A-502C through which a user may specify options relating to the timing of an animation for a selected object. The field 502A may be utilized to specify when an animation is to be started. For instance, a user may utilize the field 502A to specify that an animation “start with previous,” “start after previous,” or “start on click.” “Start with previous” allows an animation action to start at the same time as another animation. The “start after previous” logical relationship will cause an animation action to start after the completion of an immediately previous animation. The “start on click” logical relationship will cause an animation action to be initiated when a mouse click, or other suitable user input, has been received. In another embodiment, a “start on trigger” logical relationship can be defined to start an animation action when a triggering event has been detected, thereby producing an event-driven animation sequence.

The field 502B allows a user to specify the duration of an animation. Duration refers to the total time an animation takes to complete. For motion-based animations, this field also affects the speed of the animation. The field 502C allows a user to specify a period of delay prior to the start of an animation. It should be appreciated, therefore, that a user may closely control the timing of an animation by specifying appropriate values in the fields 502A-502C.

As shown in FIG. 5, the animation timing UI 114 also provides user interface controls for specifying the order in which an animation occurs with respect to other animations. In particular, the user interface button 504A may be selected to cause a selected animation to be moved earlier in time with respect to other animations. The user interface button 504B may be selected to cause a selected animation to be moved later in time with respect to other animations. Additional details regarding the use of the user interface buttons 504A-504B will be provided below.

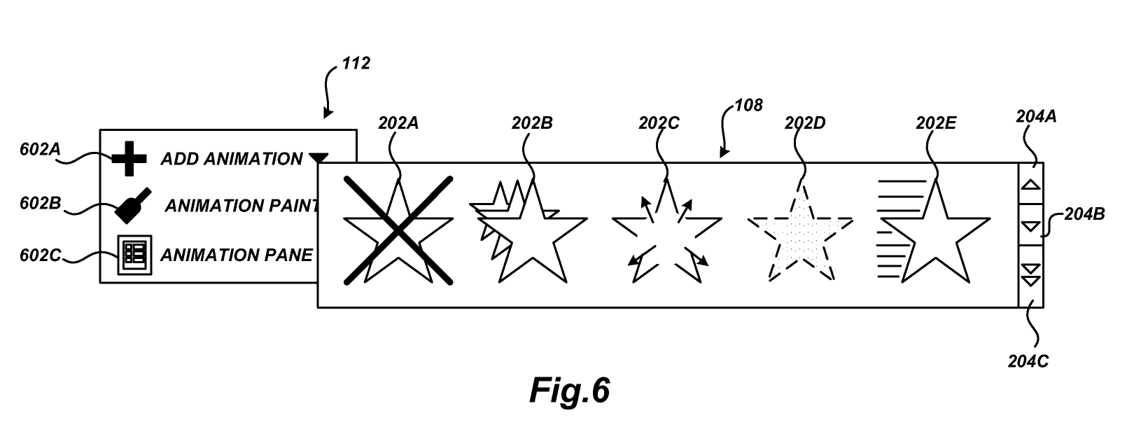

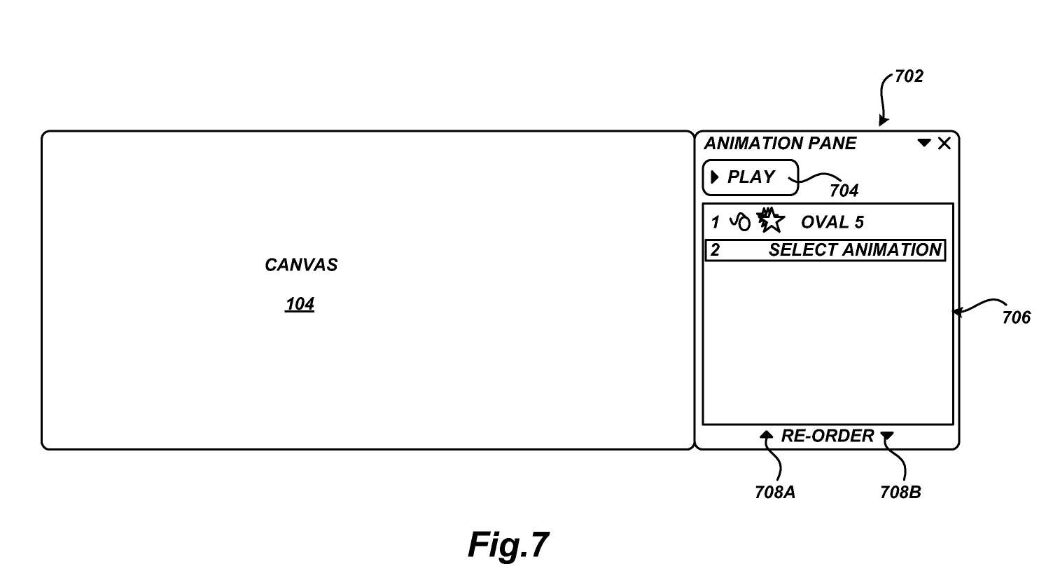

Turning now to FIG. 6, additional details will be provided regarding the user interfaces provided herein for defining a complex animation. In particular, FIG. 6 shows the custom animation UI 112 provided in one embodiment. As shown in FIG. 6, the custom animation UI 112 includes three user interface buttons 602A-602C. The user interface button 602B may be selected to copy the animations specified for one object to another object. The user interface button 602C may be selected to cause the animation pane 702 to be displayed adjacent to the canvas 104. Additional details regarding the structure and use of the animation pane 702 are provided below with respect to FIG. 7.

The user interface button 602A may be selected in order to add an animation to a selected object. In particular, selection of the user interface button 602A will cause the style gallery 108 to be displayed. As discussed above with respect to FIG. 2, the style gallery 108 includes a number of graphical representations 202A-202E corresponding to animation classes available for application to an object.

When displayed in response to the selection of the user interface button 602A, the style gallery 108 can be utilized to add an animation to the animations previously defined for an object rather than replacing those animations. For instance, in response to receiving the selection of one of the graphical representations 202A-202E from the style gallery 108, a default variant of the animation class corresponding to the selected graphical representation 202A-202E will be added as an additional animation for the selected object. If multiple objects have been selected, the default animation will be added to each of the selected objects. It should be appreciated that the style gallery 108 may be utilized in this manner multiple times in order to add multiple animations to an object.

According to one embodiment, when an animation is added to an object, the newly-added animation is immediate selected for purposes of the effects options gallery 110, the animation timing UI, and the custom animation UI 112, described below. In this manner, options may be specified with respect to the newly added animation without having to perform an additional step of selected the animation.

As described briefly above with respect to FIG. 6, selection of the user interface button 602C will cause the animation pane 702 to be displayed adjacent to the canvas 104. FIG. 7 shows an illustrative animation pane 702 provided in one embodiment herein. The animation pane 702 allows logical relationships to be defined in order to build a sequence of animation actions, which may be referred to herein as an animation sequence.

According to one implementation, the animation pane 702 includes an event list 706 that shows a time-ordered list of the animation actions that have been assigned to objects on the canvas 104. Each of the items in the event list 706 represents an individual animation and graphically conveys information regarding the type of animation action, the manner in which it will play back, and its start, end, and duration. In order to signify the start, end, and duration of each of the items, each of the items in the event list 706 may include an event timeline bar that is correlated with a universal timeline.

An appropriate user interface may be provided that allows a user to specify the desired logical relationship for each item in the event list 706. For instance, one of the items in the event list 706 may be selected using an appropriate user input device. Once an item has been selected, the user interface buttons may be utilized to move the animation corresponding to the selected item earlier or later in time, respectively, with respect to other animations. As discussed above with respect to FIG. 5, the user interface buttons 504A-504B in the animation timing UI 114 may be utilized in the same manner. A user interface button 704 is also provided in the animation pane 702 for playing back the animation corresponding to a selected item.

Turning now to FIG. 8, additional details regarding one user interface provided herein for defining a complex animation will be provided. In particular, FIG. 8 shows two objects 116B-116C that have been placed on the canvas 104. In this embodiment, each of the objects 116B-1 16C has an on-object user interface (“OOUI”) displayed adjacent to each object for providing a visual indication of the animations applied thereto, and for providing an indication when one of the animations includes two or more build steps. A build step refers to either a single animation or multiple animations that are triggered in response to the same event.

In the example shown in FIG. 8, the OOUI includes an identifier 804 for each animation or build step associated with an object. For instance, the identifiers 804A-804C are displayed adjacent to the object 116B. The identifiers 804A-804C correspond to each animation or build step associated with the object 116B and identify the order of the animations or build steps through a text label. The identifiers 804D-804E are displayed adjacent to the object 116C.

In one embodiment, a visual indication is provided on an identifier 804 when the corresponding build step includes more than one animation. For instance, in the example shown in FIG. 8, the identifier 804B includes two periods that indicate that the corresponding build step includes more than one animation. Another type of visual indication may also be provided.

A visual indication may also be provided on an identifier 804 when the height of the OOUI exceeds the height of the corresponding object. For instance, the identifier 804E on the object 116C includes a visual indication for indicating to a user that additional build steps are associated with the object 1 16C that are not represented by the OOUI. Selection of an identifier that has been collapsed in this manner will cause the animation pane 702 to be displayed.

According to embodiments, the identifiers 804 may be selected to thereby select the corresponding animation or build step. Once an animation has been selected in this manner, the user interface controls described above may be utilized to re-order the selected animation with respect to other animations. When a re-order action is performed in this manner, the identifiers 804 corresponding to the re-ordered animations may blink or be otherwise displayed in a manner to provide a visual cue that the re-ordering operation has taken place.

Referring now to FIG. 9, a routine 900 will be described that illustrates aspects of one process presented herein for defining and executing a complex animation that includes two or more animations on a single object. The routine 900 begins at operation 902, where a determination is made as to whether the user interface button 602A has been selected for adding an animation to a selected object. If so, the routine 900 proceeds to operation 904, where the style gallery 108 is displayed in the manner described above with respect to FIG. 6 and utilized to select an animation for the selected object. Once an animation class has been selected in this way, the routine 900 proceeds to operation 906, where the default variant for the selected animation class is added to the selected object. From operation 906, the routine 900 proceeds to operation 908.

If, at operation 902, it is determined that the user interface button 602A has not been selected, the routine 900 proceeds to operation 908. At operation 908, a determination is made as to whether a collapsed OOUI, such as the identifiers 804B and 804E, has been selected. If so, the routine 900 proceeds to operation 912, where the animation pane 702 is displayed and utilized in the manner described above. If, at operation 908, it is determined that a collapsed OOUI has not been selected, the routine 900 proceeds to operation 910, where a determination is made as to whether the user interface button 602C has been selected for displaying the animation pane 702. If so, the routine 900 proceeds to operation 912, where the animation pane 702 is displayed. Otherwise, the routine 900 proceeds to operation 914, where it ends.

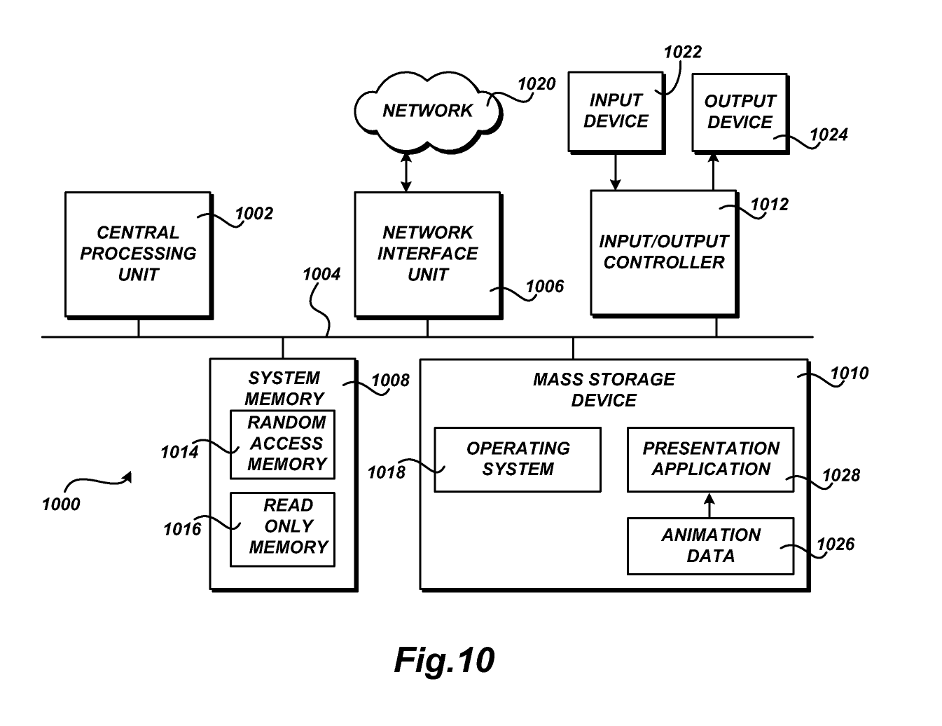

FIG. 10 shows an illustrative computer architecture for a computer 1000 capable of executing the software components described herein. The computer architecture shown in FIG. 10 illustrates a conventional desktop, laptop, or server computer and may be utilized to execute any aspects of the software components presented herein.

The computer architecture shown in FIG. 10 includes a central processing unit 1002 (“CPU”), a system memory 1008, including a random access memory 1014 (“RAM”) and a read-only memory (“ROM”) 1016, and a system bus 1004 that couples the memory to the CPU 1002. A basic input/output system containing the basic routines that help to transfer information between elements within the computer 1000, such as during startup, is stored in the ROM 1016. The computer 1000 further includes a mass storage device 1010 for storing an operating system 1018, application programs, and other program modules, which have been described in greater detail herein.

The mass storage device 1010 is connected to the CPU 1002 through a mass storage controller (not shown) connected to the bus 1004. The mass storage device 1010 and its associated computer-readable media provide non-volatile storage for the computer 1000. Although the description of computer-readable media contained herein refers to a mass storage device, such as a hard disk or CD-ROM drive, it should be appreciated by those skilled in the art that computer-readable media can be any available computer storage media that can be accessed by the computer 1000.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1000.

According to various embodiments, the computer 1000 may operate in a networked environment using logical connections to remote computers through a network such as the network 1020. The computer 1000 may connect to the network 1020 through a network interface unit 1006 connected to the bus 1004. It should be appreciated that the network interface unit 1006 may also be utilized to connect to other types of networks and remote computer systems. The computer 1000 may also include an input/output controller 1012 for receiving and processing input from a number of other devices, including a keyboard, mouse, electronic stylus, or other type of input device 1022. Similarly, an input/output controller may provide output to a display screen, a printer, or other type of output device 1024.

As mentioned briefly above, a number of program modules and data files may be stored in the mass storage device 1010 and RAM 1014 of the computer 1000, including an operating system 1018 suitable for controlling the operation of a networked desktop, laptop, or server computer. The mass storage device 1010 and RAM 1014 may also store one or more program modules. In particular, the mass storage device 1010 and the RAM 1014 may store a presentation application 1028 and data 1026 defining the animations made available through the user interfaces presented above, each of which was described in detail above with respect to FIGS. 1-9. The mass storage device 1010 and the RAM 1014 may also store other types of program modules and data.

Based on the foregoing, it should be appreciated that technologies for defining both simple and complex animations are provided herein. Although the subject matter presented herein has been described in language specific to computer structural features, methodological acts that include transformations, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-readable medium having computer-readable instructions stored thereon which, when executed by a computer, cause the computer to:
execute a program module for generating an animation of an object, the program module being configured to provide a unified user interface comprising a user interface for defining a single animation with respect to an object and a user interface for defining two or more animations with respect to a single object; and to
execute the program module to generate the unified user interface on a display screen, to receive user input via the user interface for defining a single animation with respect to an object defining a single animation, and to transform data defining the single animation to generate a display of the defined animation on the display screen.

2. The computer-readable medium of claim 1, having further computer-readable instructions stored thereon which, when executed by the computer, cause the computer to receive user input via the user interface for defining two or more animations animation with respect to a single object that defines two or more animations with respect to a single object, and to transform data defining the animations to generate a display of the defined animations on the display screen.

3. The computer-readable medium of claim 1, wherein the user interface for defining a single animation comprises a style gallery for selecting a single animation class to be applied to the object.

4. The computer-readable medium of claim 3, wherein the user interface for defining a single animation further comprises an effects options gallery for specifying one or more variants of a selected animation class.

5. The computer-readable medium of claim 1, wherein the user interface for defining two or more animations with respect to a single object comprises an animation timing user interface for specifying a timing for the animation.

6. The computer-readable medium of claim 5, wherein the user interface for defining two or more animations with respect to a single object comprises a style gallery for selecting two or more animation classes to be applied to the object.

7. The computer-readable medium of claim 6, wherein the user interface for defining two or more animations with respect to a single object further comprises one or more user interface controls for specifying an order of the two or more animations.

8. The computer-readable medium of claim 7, wherein the user interface for defining two or more animations with respect to a single object further comprises an on-object user interface (OOUI) for providing a visual indication of the two or more animations and for providing an indication when one of the animations includes two or more build steps.

9. An apparatus for defining and displaying both simple and complex animations with respect to an object, the apparatus comprising:
a central processing unit;
a display screen;
a system memory; and
a mass storage device, the mass storage device having an application stored thereupon for animating the object, the application comprising computer-executable instructions which, when loaded into the system memory and executed by the central processing unit, will cause the apparatus to provide a unified user interface comprising a first user interface for defining a single animation with respect to the object and a second user interface for defining two or more animations with respect to the object, to receive user input via the unified user interface specifying one or more animations with respect to the object, and to transform data defining the specified animations to provide a visual display of the one or more animations on the display screen.

10. The apparatus of claim 9, wherein the first user interface comprises a style gallery for selecting a single animation class to be applied to the object.

11. The apparatus of claim 10, wherein the first user interface further comprises an effects options gallery for specifying one or more variants of a selected animation class.

12. The apparatus of claim 11, wherein the second user interface comprises one or more user interface controls for specifying an order of the two or more animations.

13. The apparatus of claim 12, wherein the second user interface further comprises a style gallery for selecting two or more animation classes to be applied to the object.

14. The apparatus of claim 13, wherein the second user interface further comprises an on-object user interface (OOUI) for providing a visual indication of the two or more animations and for providing an indication when one of the animations includes two or more build steps.

15. A computer-implemented method for defining an animation, the method comprising performing computer-implemented operations for:
storing a program module for creating a presentation at a computer system having an input device, a display screen, and a computer-readable medium having the program module stored thereupon;
storing data on the computer-readable medium of the computer system defining a plurality of animations that may be applied to an object to generate an animation on the display screen;
executing the program module at the computer system to retrieve the data and to transform the data for use in providing a unified user interface for defining a single animation and for defining a custom animation with respect to an object, the unified user interface comprising a first user interface for defining a single animation with respect to an object and a second user interface for defining two or more animations with respect to the same object;
receiving by way of the first user interface first user input defining a single animation with respect to an object and, in response to receiving the first user input, transforming the data defining the animations to provide a visual display of the single animation on the display screen; and
receiving by way of the second user interface second user input defining two or more animations with respect to the object and, in response to receiving the second user input, transforming the data defining the animations to provide a visual display of the two or more animations on the display screen.

16. The computer-implemented method of claim 15, wherein the first user interface comprises a style gallery for selecting a single animation class to be applied to the object.

17. The computer-implemented method of claim 16, wherein the first user interface for defining the single animation further comprises an effects options gallery for specifying one or more variants of a selected animation class.

18. The computer-implemented method of claim 17, wherein the second user interface for defining the two or more animations further comprises an animation timing user interface for specifying a timing for the animation.

19. The computer-implemented method of claim 18, wherein the second user interface for defining the two or more animations comprises one or more user interface controls for specifying an order of the two or more animations.

20. The computer-implemented method of claim 19, wherein the second user interface for defining the two or more animations comprises a style gallery for selecting the two or more animations to be applied to the object.
